(19) United States
(12) Patent Application Publication
(10) Pub. No.: US 2025/0280253 A1
(43) Pub. Date: Sep. 4, 2025

(54) WIRE DAMPER OF LOUDSPEAKER WITH YARNS AT BOTH SIDES OF A WIRE ASSEMBLY BEING IN AN ARC FORM AND THE METHOD FOR MANUFACTURING THE SAME

(71) Applicant: Hiroko OHARA, Taoyuan (TW)

(72) Inventor: Hiroko OHARA, Taoyuan (TW)

(21) Appl. No.: 18/636,377

(22) Filed: Apr. 16, 2024

(30) Foreign Application Priority Data
Mar. 4, 2024 (TW) 113107778

(51) Int. Cl. H04R 31/00; H04R 9/04

(52) U.S. Cl. CPC H04R 31/00; H04R 9/043; H04R 2231/003

(57) ABSTRACT

A method for manufacturing a wire damper of loudspeaker with yarns at both sides of a wire assembly being arc-shaped, including: weaving yarns into a base material, and disposing wire assemblies at wire disposing areas of the base material, each wire assembly being composed of multiple wires, each wire being a monofilament thread; impregnating the base material in a resin solution; drying the base material to form a solid resin layer on the base material; thermoforming a wire damper of a loudspeaker on the base material wherein the yarns at both sides of each wire assembly are arc-shaped to form two elastic adjustment areas; and separating the wire damper of loudspeaker from the base material. Thereby, the hardness, elasticity and toughness of the wire disposing areas can be jointly adjusted through the elastic adjustment areas, such that the wire damper of loudspeaker has uniform hardness, elasticity and toughness.

### CROSS-REFERENCE TO RELATED APPLICATION

This application claims the priority of Taiwanese patent application No. 113107778, filed on Mar. 4, 2024, which is incorporated herewith by reference.

### BACKGROUND OF THE INVENTION

### 1. Field of the Invention

The present invention relates to a wire damper of loudspeaker and a method for manufacturing the same, and more particularly, to a wire damper of loudspeaker with yarns at both sides of a wire assembly being in an arc form and a method for manufacturing the same.

### 2. The Prior Arts

In the general moving coil loudspeaker, the principle that the reaction force of a fixed magnetic field causes another magnetic field to move in the opposite direction (i.e., opposite magnetisms attract each other, and like magnetisms repels each other) is used to produce sound. Further, the power alternating current generated by the power amplifier is transmitted to the voice coil through a wire to change the polarity of the magnetic field, such that the voice coil generates a reaction force against the fixed magnetic region generated by the magnetic circuit device. A forward pulse causes an outward motion of the diaphragm relative to the magnet, while a backward pulse causes an inward motion of the diaphragm. When the voice coil pushes the diaphragm to reciprocate, the diaphragm pushes air, and the air pressure changes to form sound waves. The damper is responsible for maintaining the voice coil at a correct position in the gap of the magnet core, ensuring that the voice coil reciprocates along the axis direction when being forced.

A conventional wire damper of loudspeaker comprises a main body, a plurality of wire assemblies and a solid resin layer. The main body is woven from a plurality of yarns, and has a plurality of wire disposing areas. The wire assemblies are disposed respectively on the wire disposing areas, each wire assembly is composed of a plurality of wires, and each wire is a monofilament thread. The solid resin layer covers the surface of the yarns and the wire assemblies.

However, the wire assemblies are harder than the yarns, and the elasticity and toughness of the wire assemblies are worse than that of the yarns, so that the wire disposing areas are harder than the other areas of the wire damper of the loudspeaker, and the elasticity and toughness of the wire disposing areas are worse than that of the other areas of the wire damper of the loudspeaker. Therefore, the hardness, elasticity, and toughness of the wire damper of the loudspeaker are non-uniform, resulting in non-uniform elastic resilience and fatigue resistance of the wire damper of the loudspeaker, which causes the wire damper of the loudspeaker to be easily deformed, thereby affecting the output sound quality of the loudspeaker.

### SUMMARY OF THE INVENTION

A main objective of the present invention is to provide a wire damper of a loudspeaker with yarns at both sides of a wire assembly being in an arc form and a method for manufacturing the same, in which the hardness, elasticity and toughness of the wire disposing areas can be adjusted through the elastic adjustment areas.

In order to achieve the above objective, the present invention provides a method for manufacturing a wire damper of a loudspeaker with yarns at both sides of a wire assembly being in an arc form, comprising: weaving a plurality of yarns into a base material, and disposing a plurality of wire assemblies respectively at a plurality of wire disposing areas of the base material, wherein each wire assembly is composed of a plurality of wires, and each wire is a monofilament thread; impregnating the base material in a resin solution; drying the base material to form a solid resin layer on the base material; forming a wire damper of a loudspeaker on the base material by thermoforming in a manner that the yarns at both sides of each wire assembly are in an arc form to form two elastic adjustment areas; and separating the wire damper of the loudspeaker from the base material.

In some embodiments, in the step of disposing the wire assemblies respectively on the wire disposing areas, a plurality of warp yarns of the yarns and the wire assemblies extend straightly and are parallel to each other, and a plurality of weft yarns of the yarns extend straightly and are perpendicular to the warp yarns and the wire assemblies; wherein in the step of forming the wire damper of the loudspeaker by thermoforming, the weft yarns at both sides of each wire assembly are in an arc form and form the elastic adjustment areas along with the warp yarns at both sides of each wire assembly.

In some embodiments, in the step of disposing the wire assemblies respectively on the wire disposing areas, a plurality of warp yarns of the yarns extend straightly and are parallel to each other, and a plurality of weft yarns of the yarns and the wire assemblies extend straightly and are perpendicular to the warp yarns; wherein in the step of forming the wire damper of the loudspeaker by thermoforming, the warp yarns at both sides of each wire assembly are in an arc form and form the elastic adjustment areas along with the weft yarns at both sides of each wire assembly.

In some embodiments, in the step of forming the wire damper of the loudspeaker by thermoforming, the yarns at both sides of each wire assembly are in an asymmetrical arc form.

In some embodiments, in the step of weaving the base material, the wire assemblies are woven, sewn, adhered, or sandwiched into the base material.

In order to achieve the above objective, the present invention provides a wire damper of a loudspeaker with yarns at both sides of a wire assembly being in an arc form, comprising: a main body, a plurality of wire assemblies, and a solid resin layer. The main body is woven from a plurality of yarns, and has a plurality of wire disposing areas. The wire assemblies are disposed respectively on the wire disposing areas, wherein each wire assembly is composed of a plurality of wires, and each wire is a monofilament thread. The solid resin layer covers surfaces of the yarns and the wires. Wherein the yarns at both sides of each wire assembly are in an arc form to form two elastic adjustment areas.

In some embodiments, the yarns include a plurality of warp yarns and a plurality of weft yarns, the warp yarns and the wire assemblies extend straightly and are parallel to each other, and the weft yarns extend straightly and are perpendicular to the warp yarns and the wire assemblies; wherein the weft yarns at both sides of each wire assembly are in an arc form and form the elastic adjustment areas along with the warp yarns at both sides of each wire assembly.

In some embodiments, the yarns include a plurality of warp yarns and a plurality of weft yarns, the warp yarns extend straightly and are parallel to each other, and the weft yarns and the wire assemblies extend straightly and are perpendicular to the warp yarns; wherein the warp yarns at both sides of each wire assembly are in an arc form and form the elastic adjustment areas along with the weft yarns at both sides of each wire assembly.

In some embodiments, the yarns at both sides of each wire assembly are in an asymmetrical arc form.

In some embodiments, the wire assemblies are woven, sewn, adhered, or sandwiched into the main body.

The present invention has the advantageous in that the hardness, elasticity and toughness of the wire disposing areas can be jointly adjusted through the elastic disposing areas, such that the wire disposing areas become softer and have increased elasticity and toughness, the hardness, elasticity, and toughness of the wire disposing areas and the wire assemblies are comparable to that of the other areas of the wire damper of the loudspeaker. Therefore, the wire damper of the loudspeaker has uniform hardness, elasticity and toughness, thereby having uniform elastic resilience and fatigue resistance, and being not easy to be deformed and brittle, which improves the output sound quality of the loudspeaker.

### BRIEF DESCRIPTION OF THE DRAWINGS

FIG. 1 is a flow diagram of a manufacturing method of the present invention;

FIG. 2 is a schematic diagram of a step S10 of a manufacturing method of a first embodiment of the present invention;

FIG. 3 is a schematic diagram of steps S20 to S50 of the manufacturing method of the first embodiment of the present invention;

FIG. 4 is a perspective view of a wire damper of a loudspeaker of the first embodiment of the present invention;

FIG. 5 is a schematic diagram of a region A of FIG. 4;

FIG. 6 is a schematic diagram of the step S10 of a manufacturing method of a second embodiment of the present invention;

FIG. 7 is a perspective view of a wire damper of a loudspeaker of the second embodiment of the present invention;

FIG. 8 is a schematic diagram of a region B of FIG. 7;

FIG. 9 is a schematic diagram of a step S10 of a manufacturing method of a third embodiment of the present invention;

FIG. 10 is a perspective view a wire damper of a loudspeaker of the third embodiment of the present invention;

FIG. 11 is a schematic diagram of a region C of FIG. 10;

FIG. 12 is a schematic diagram of a step S10 of a manufacturing method of a fourth embodiment of the present invention;

FIG. 13 is a perspective view of a wire damper of a loudspeaker of the fourth embodiment of the present invention;

FIG. 14 is a schematic diagram of a region D of FIG. 13;

FIG. 15 is a schematic diagram of a step S10 of a manufacturing method of a fifth embodiment of the present invention;

FIG. 16 is a perspective view of a wire damper of a loudspeaker of the fifth embodiment of the present invention;

FIG. 17 is a schematic diagram of a region E of FIG. 16;

FIG. 18 is a schematic diagram of a step S10 of a manufacturing method of a sixth embodiment of the present invention;

FIG. 19 is a perspective view of a wire damper of a loudspeaker of a sixth embodiment of the present invention; and

FIG. 20 is a schematic diagram of a region F of FIG. 19.

### DETAILED DESCRIPTION OF THE PREFERRED EMBODIMENT

Hereinafter, embodiments of the present invention will be described in more detail with reference to the drawings and the reference numerals, such that those skilled in the art can implement it after studying this specification.

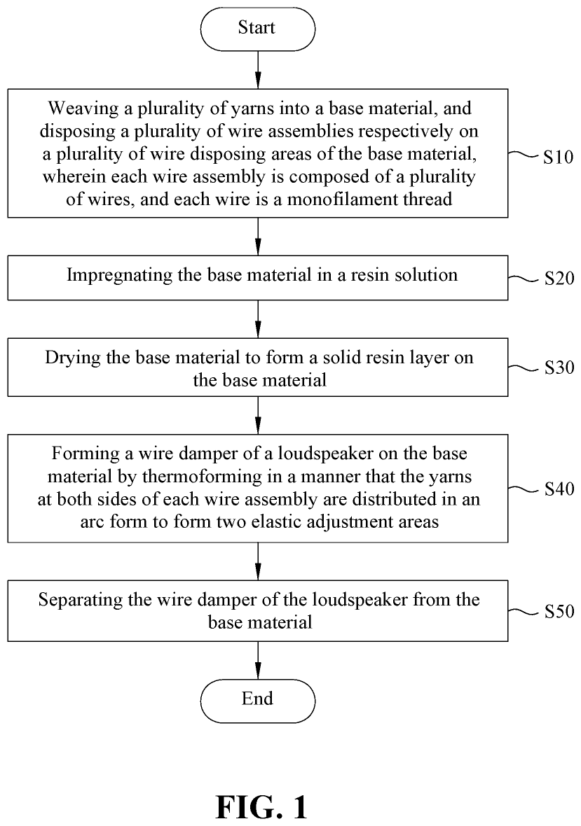

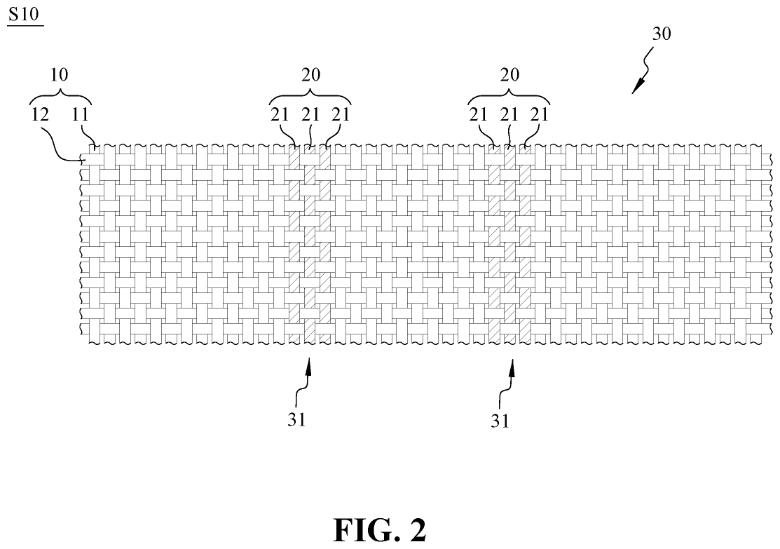

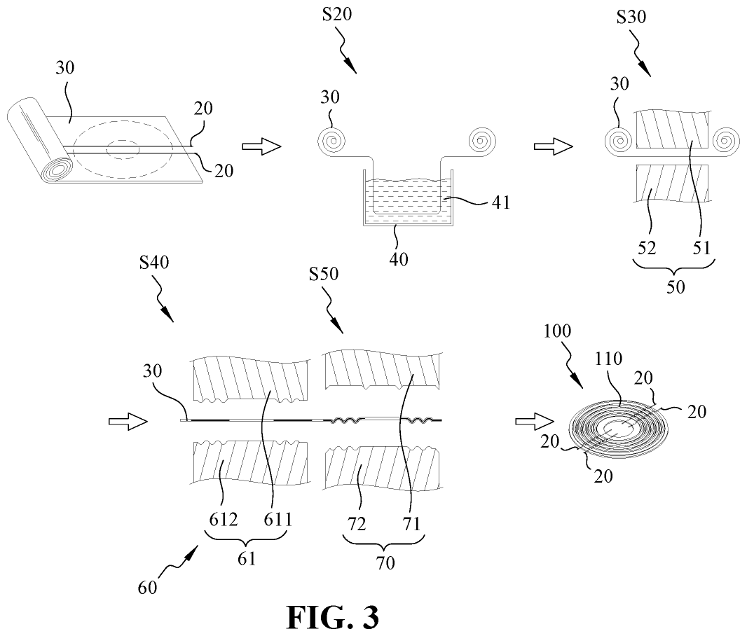

FIG. 1 is a flow diagram of a manufacturing method of the present invention. FIG. 2 is a schematic diagram of a step S10 of a manufacturing method of a first embodiment of the present invention. FIG. 3 is a schematic diagram of steps S20 to S50 of the manufacturing method of the first embodiment of the present invention. The present invention provides a method for manufacturing a wire damper of a loudspeaker with yarns at both sides of a wire assembly being in an arc form, comprising the following steps S10˜S50:

In the step S10, as shown in FIGS. 1 and 2, a plurality of yarns 10 are woven into a base material 30, and a plurality of wire assemblies 20 are disposed respectively on a plurality of wire disposing areas 31 of the base material 30. Each wire assembly 20 is composed of a plurality of wires 21, each wire 21 is a monofilament thread, and the wires 21 are arranged at intervals.

Specifically, a plurality of warp yarns 11 of the yarns 10 and the wire assemblies 20 extend straightly and are parallel to each other, and a plurality of weft yarns 12 of the yarns 10 extend straightly and are perpendicular to the warp yarns 11 and the wire assemblies 20.

In the first embodiment, in the step S10, the warp yarns 11 and the wire assemblies 20 are arranged at intervals, the warp yarns 11 and the wire assemblies 20 extend straightly and are parallel to each other, and the weft yarns 12 are interwoven with the warp yarns 11 and the wire assemblies 20, so as to weave the base material 30.

In some embodiments, in the step S10, the wire assemblies 20 are sewn on base material 30 by a plurality of sewing threads. In some embodiments, in the step S10, the wire assemblies 20 are adhered on the base material 30 by a plurality of adhesive layers. In some embodiments, in the step S10, the wire assemblies 20 are sandwiched between two base materials 30.

In the step S20, as shown in FIGS. 1 and 3, the base material 30 is impregnated in a resin solution 41 in a resin tank 40, such that the warp yarns 11, the weft yarns 12, and the wires 21 adsorb the resin and are adhered with the resin.

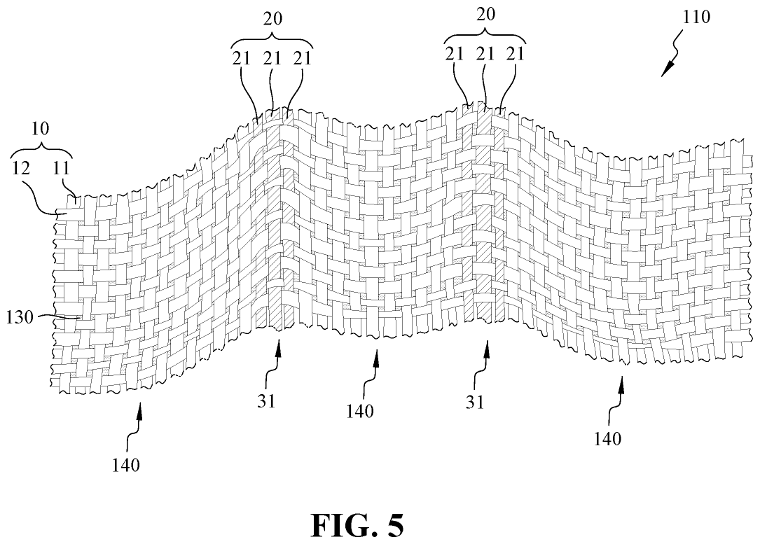

In the step S30, as shown in FIGS. 1 and 3, a drying device 50, which includes an upper baking plate 51 and a lower baking plate 52, is used, wherein by utilizing the temperature of the upper baking plate 51 and the lower baking plate 52, the moisture and volatile substances in the resin on the base material 30 are removed such that the base material 30 is dried; meanwhile, the resin penetrates into the base material 30 and is adhered onto the warp yarns 11, the weft yarns 12, and the wires 21, so as to form a solid resin layer 130 (referring to FIG. 5), the solid resin layer 130 covers surfaces of the warp yarns 11, the weft yarns 12 and the wires 21.

In the step S40, as shown in FIGS. 1 and 3, a thermoforming device 60, which includes a forming mold 61 and a heating device (not shown), is used, wherein the forming mold 61 includes an upper mold 611 and a lower mold 612. When the upper mold 611 and the lower mold 612 fit together and press the base material 30, the heating device is applied with electricity to increase the temperature of the upper mold 611 and the lower mold 612 to 190° C. to 270° C., thereby softening the resin on the base material 30. In addition that the resin structure is broken, the resin also fills up the gaps, and thus respective parts of the resin are connected with each other to form the final morphology of the solid resin layer 130, so as to cover between the warp yarns 11, the weft yarns 12 and the wires 21, thereby forming a wire damper of loudspeaker 100 on the base material 30 by thermoforming. Importantly, the weft yarns 12 at both sides of each wire assembly 20 are in an arc form and form two elastic adjustment areas 140 along with the warp yarns 11 at both sides of each wire assembly 20 (referring to FIG. 5). Preferably, the weft yarns 12 at both sides of each wire assembly 20 are in an asymmetrical arc form (referring to FIG. 5).

In the step S50, as shown in FIGS. 1 and 3, a cutting device 70, which includes an upper cutting tool 71 and a lower cutting tool 72, is used, wherein the wire damper of loudspeaker 100 is cut from the base material 30 by the upper cutting tool 71 and the lower cutting tool 72, such that the wire damper of loudspeaker 100 is separated from the base material 30.

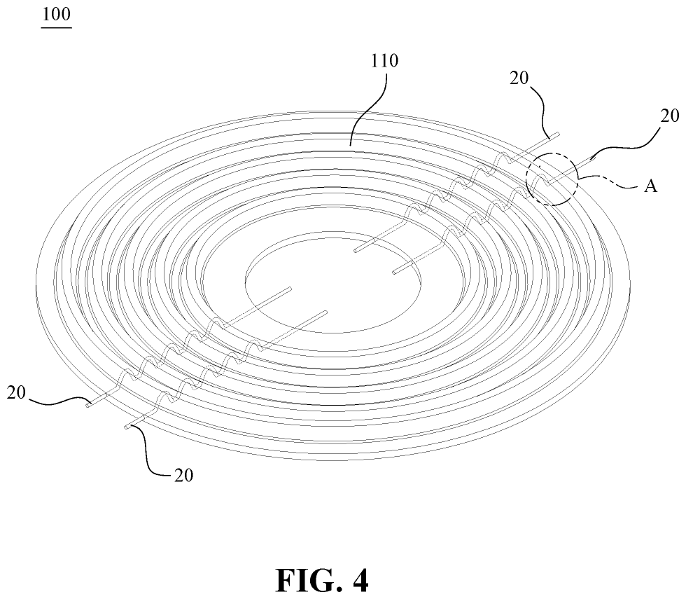

FIG. 4 is a perspective view of the wire damper of loudspeaker 100 of the first embodiment of the present invention. FIG. 5 is a schematic diagram of a region A of FIG. 4. As shown in FIGS. 4 and 5, the present invention provides a wire damper of loudspeaker 100 with yarns at both sides of a wire assembly being in an arc form, comprising a main body 110, a plurality of wire assemblies 20, and a solid resin layer 130. The main body 110 is woven from a plurality of yarns 10, and has a plurality of wire disposing areas 31. The wire assemblies 20 are dispose respectively on the wire disposing areas 31, each wire assembly 20 is composed of a plurality of wires 21, and each wire 21 is a monofilament thread. The solid resin layer 130 covers surfaces of the yarns 10 and the wires 21.

In particular, the yarns 10 include a plurality of warp yarns 11 and a plurality of weft yarns 12, the warp yarns 11 and the wire assemblies 20 extend straightly and are parallel to each other, and the weft yarns 12 extend straightly and are perpendicular to the warp yarns 11 and the wire assemblies 20. Importantly, the weft yarns 12 at both sides of each wire assembly 20 are in an arc form and form two elastic adjustment areas 140 along with the warp yarns 11 at both sides of each wire assembly 20. Preferably, the weft yarns 12 at both sides of each wire assembly 20 are in an asymmetrical arc form.

In the first embodiment, the warp yarns 11 and the wire assemblies 20 are arranged at intervals, the warp yarns 11 and the wire assemblies 20 extend straightly and are parallel to each other, and the weft yarns 12 are interwoven with the warp yarns 11 and the wire assemblies 20, so as to weave the main body 110.

In some embodiments, the wire assemblies 20 are sewn on the main body 110 by a plurality of sewing threads. In some embodiments, the wire assemblies 20 are adhered on the main body 110 by a plurality of adhesive layers. In some embodiments, the wire assemblies 20 are sandwiched between two main bodies 110.

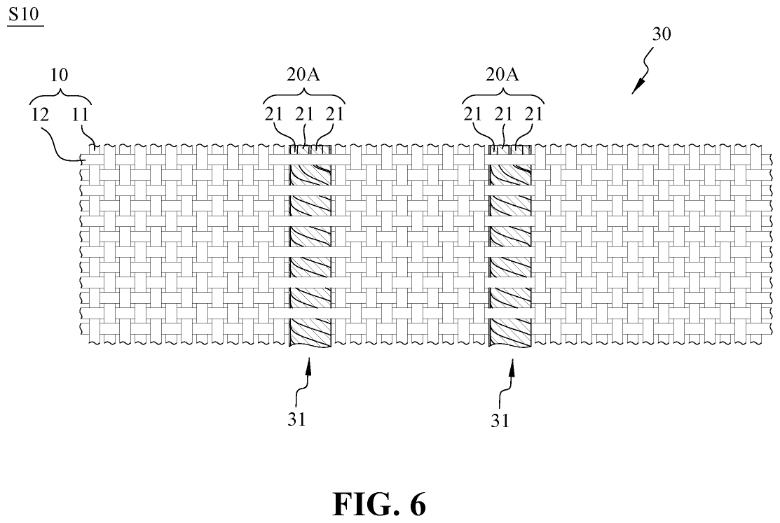

FIG. 6 is a schematic diagram of the step S10 of a manufacturing method of a second embodiment of the present invention. As shown in FIG. 6, in terms of method, the second embodiment is different from the first embodiment in that in the step S10, the wires 21 are blended-twisted, such that each wire assembly 20A forms a multifilament thread with a circular cross-section.

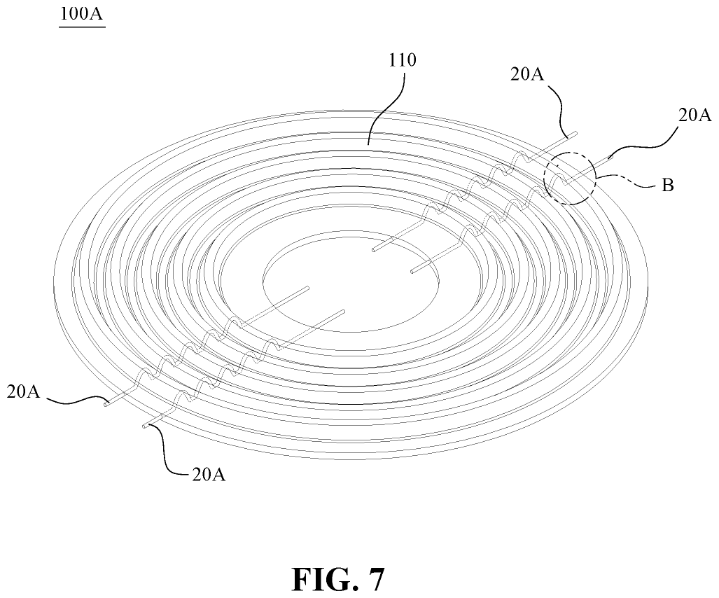

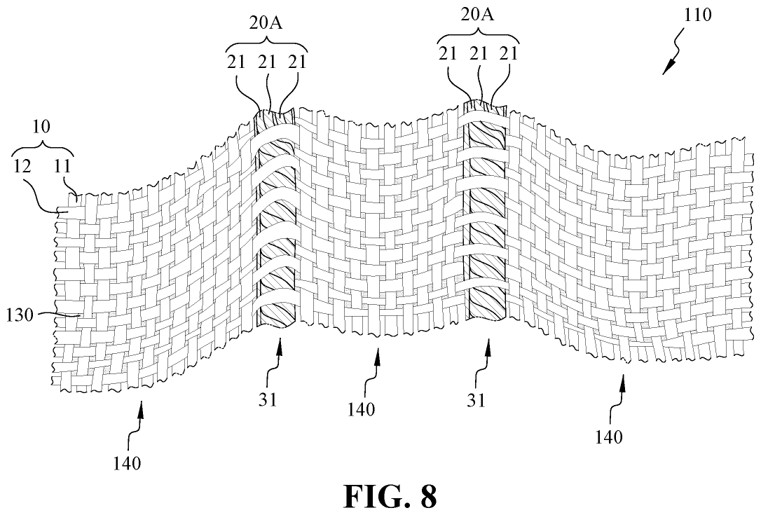

FIG. 7 is a perspective view of a wire damper of loudspeaker 100A of the second embodiment of the present invention. FIG. 8 is a schematic diagram of a region B of FIG. 7. As shown in FIGS. 7 and 8, in terms of structure, the wires 21 are blended-twisted, such that each wire assembly 20A forms a multifilament thread with a circular cross-section.

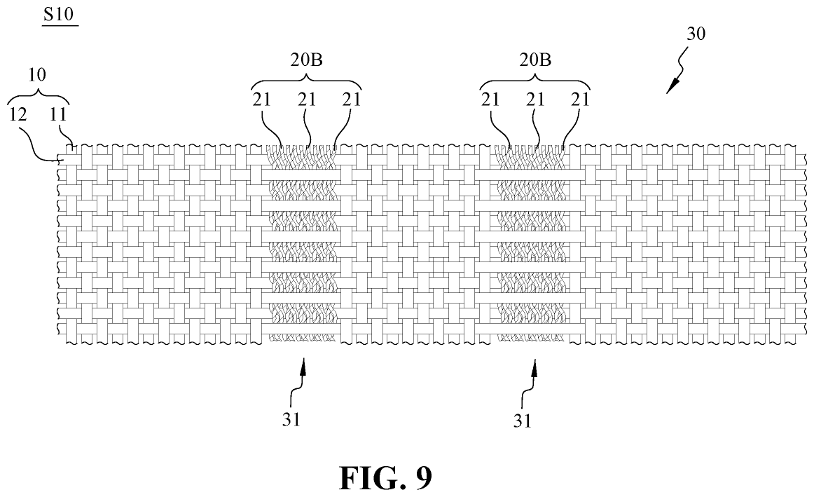

FIG. 9 is a schematic diagram of a step S10 of a manufacturing method of a third embodiment of the present invention. As shown in FIG. 9, in terms of method, the third embodiment is different from the first embodiment and the second embodiment in that in the step S10, the wires 21 are braided with each other, such that each wire assembly 20A forms a multifilament thread with a flat cross-section.

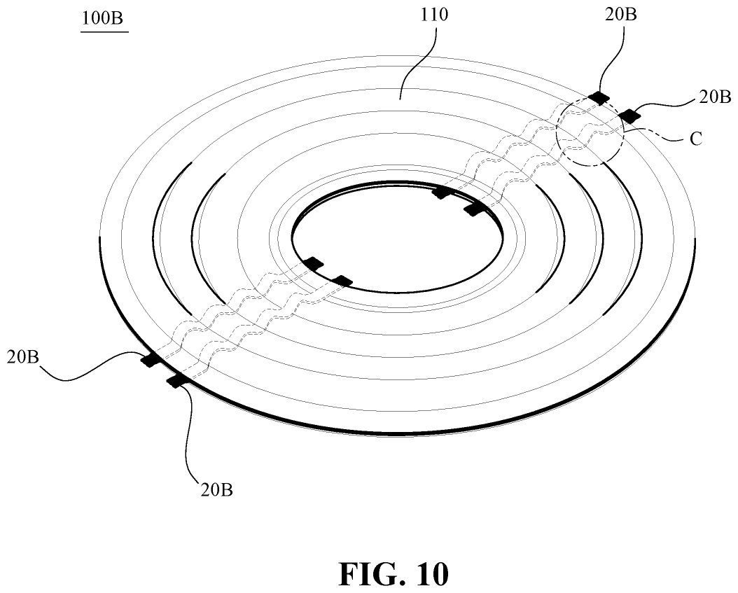

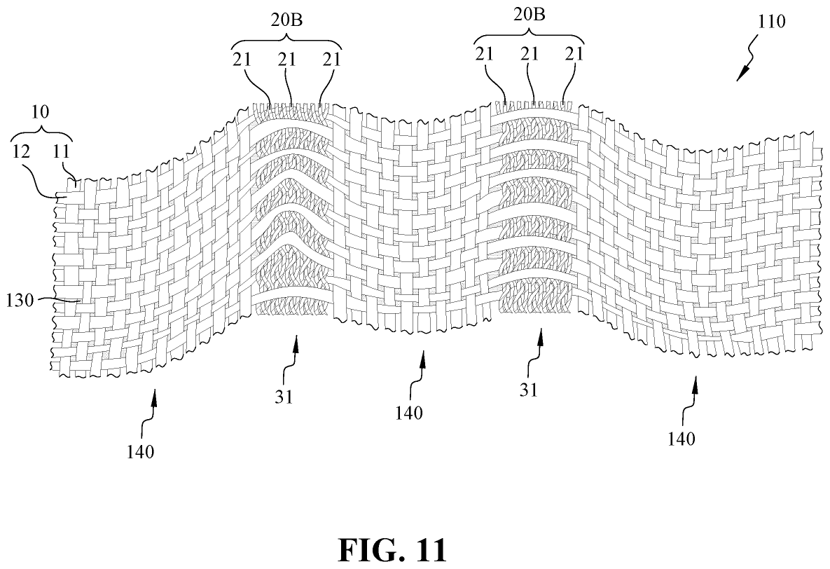

FIG. 10 is a perspective view a wire damper of loudspeaker 100B of the third embodiment of the present invention. FIG. 11 is a schematic diagram of a region C of FIG. 10. As shown in FIGS. 10 and 11, in terms of structure, the third embodiment is different from the previous embodiments in that the wires 21 are braided with each other, such that each wire assembly 20A forms a multifilament thread with a flat cross-section.

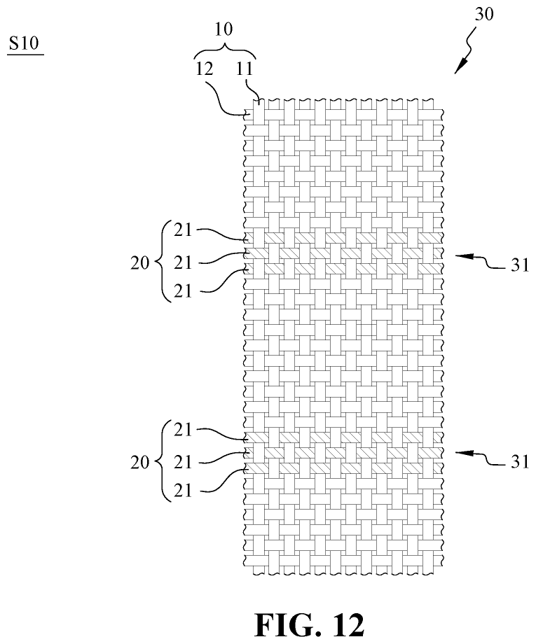

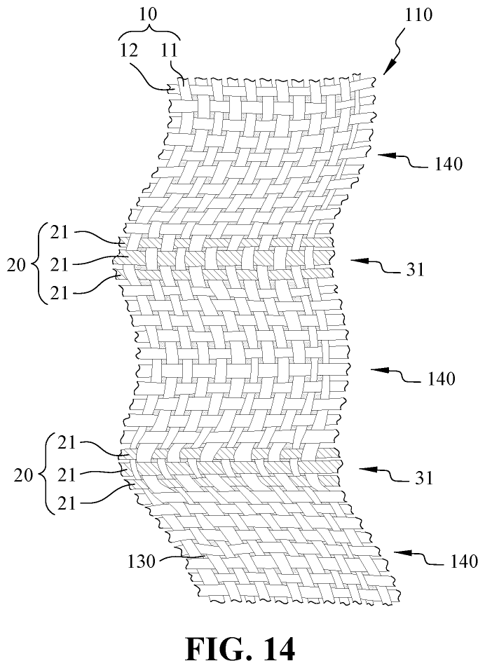

FIG. 12 is a schematic diagram of a step S10 of a manufacturing method of a fourth embodiment of the present invention. As shown in FIG. 12, in terms of method, the fourth embodiment is different from the first embodiment in that: first, in the step S10, the warp yarns 11 extend straightly and are parallel to each other, and the weft yarns 12 and the wire assemblies 20 extend straightly and are perpendicular to the warp yarns 11. Specifically, in the step S10, the warp yarns 11 are arranged at intervals and extend straightly; and the weft yarns 12 and the wire assemblies 20 are arranged at intervals and interwoven with the warp yarns 11, so as to weave the base material 30. Second, in the step S40, the warp yarns 11 at both sides of each wire assembly 20 are in an arc form and form two elastic adjustment areas 140 along with the weft yarns 12 at both sides of each wire assembly 20 (referring to FIG. 14). Preferably, the warp yarns 11 at both sides of each wire assembly 20 are in an asymmetrical arc form (referring to FIG. 14).

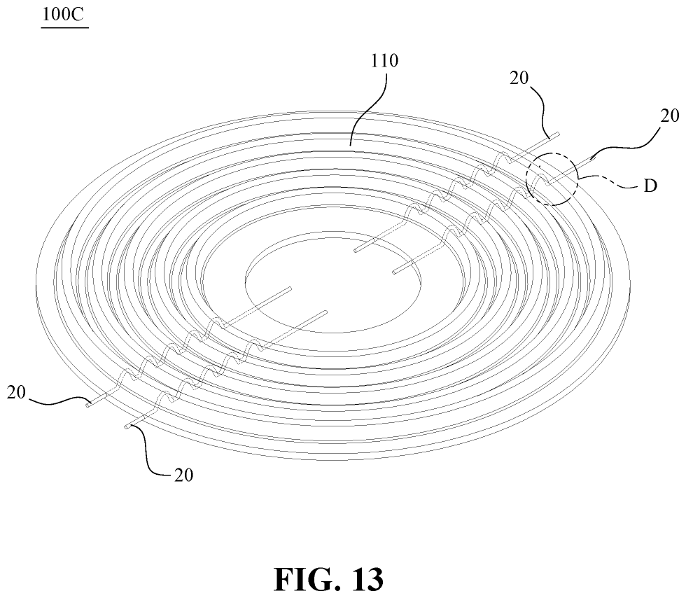

FIG. 13 is a perspective view of a wire damper of loudspeaker 100C of the fourth embodiment of the present invention. FIG. 14 is a schematic diagram of a region D of FIG. 13. As shown in FIGS. 13 and 14, in terms of structure, the fourth embodiment is different from the first embodiment in that, first, the warp yarns 11 extend straightly and are parallel to each other, and the weft yarns 12 and the wire assemblies 20 extend straightly and are perpendicular to the warp yarns 11. Specifically, the warp yarns 11 are arranged at intervals and extend straightly; and the weft yarns 12 and the wire assemblies 20 are arranged at intervals and interwoven with the warp yarns 11, so as to weave a main body 110. Second, the warp yarns 11 at both sides of each wire assembly 20 are in an arc form and form two elastic adjustment areas 140 along with the weft yarns 12 at both sides of each wire assembly 20. Preferably, the warp yarns 11 at both sides of each wire assembly 20 are in an asymmetrical arc form.

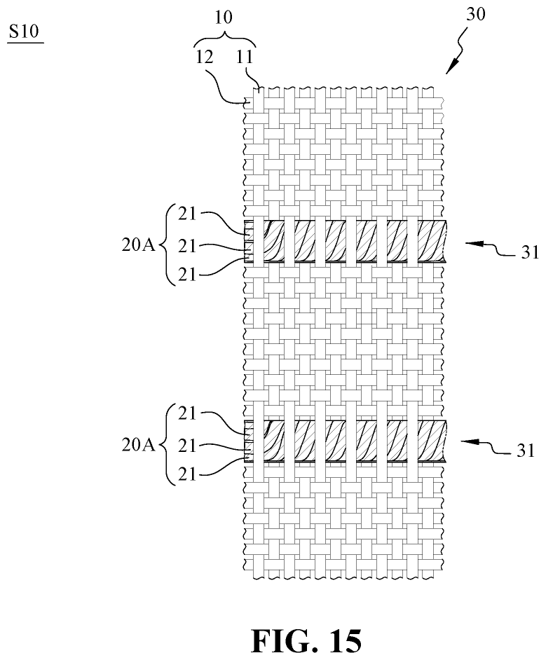

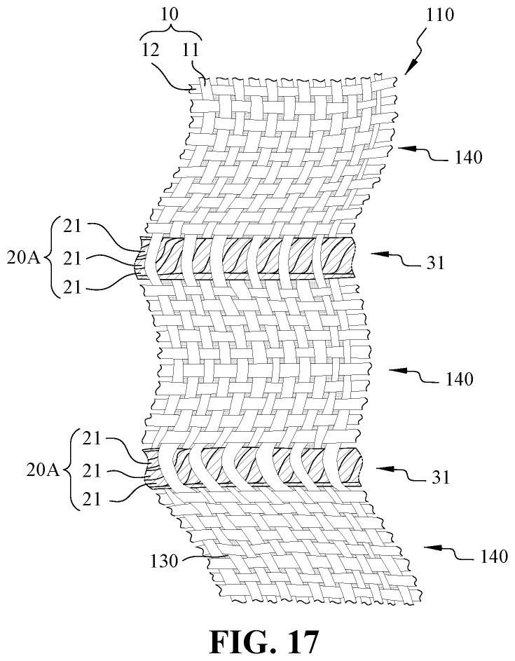

FIG. 15 is a schematic diagram of a step S10 of a manufacturing method of a fifth embodiment of the present invention. As shown in FIG. 15, in terms of method, the fifth embodiment is different from the second embodiment in that, first, in the step S10, the warp yarns 11 extend straightly and are parallel to each other, and the weft yarns 12 and the wire assemblies 20A extend straightly and are perpendicular to the warp yarns 11. Specifically, in the step S10, the warp yarns 11 are arranged at intervals and extend straightly; and the weft yarns 12 and the wire assemblies 20A are arranged at intervals and interwoven with the warp yarns 11, so as to weave a base material 30. Second, in the step S40, the warp yarns 11 at both sides of each wire assembly 20A are in an arc form and form two elastic adjustment areas 140 along with the weft yarns 12 at both sides of each wire assembly 20A (referring to FIG. 17). Preferably, the warp yarns 11 at both sides of each wire assembly 20 are in an asymmetrical arc form (referring to FIG. 17).

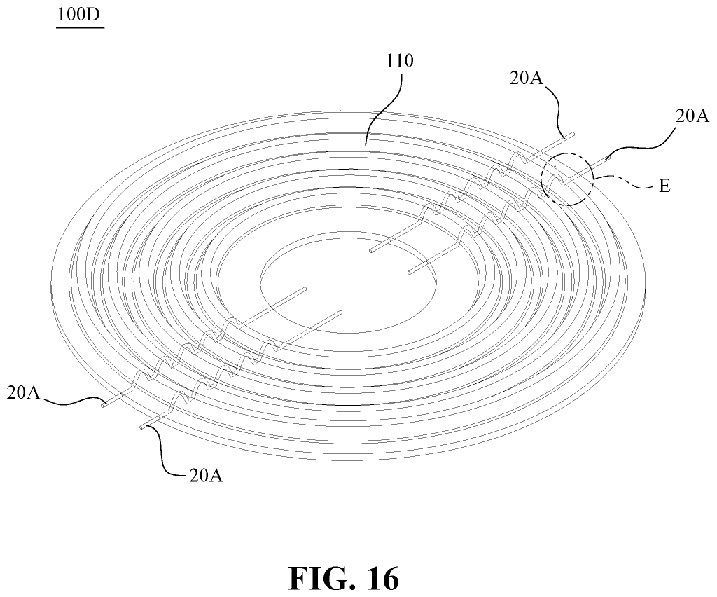

FIG. 16 is a perspective view of a wire damper of loudspeaker 100D of the fifth embodiment of the present invention. FIG. 17 is a schematic diagram of a region E of FIG. 16. As shown in FIGS. 16 and 17, in terms of structure, the fifth embodiment is different from the second embodiment in that, first, the warp yarns 11 extend straightly and are parallel to each other, and the weft yarns 12 and the wire assemblies 20A extend straightly and are perpendicular to the warp yarns 11. Specifically, the warp yarns 11 are arranged at intervals and extend straightly; and the weft yarns 12 and the wire assemblies 20A are arranged at intervals and interwoven with the warp yarns 11, so as to weave a main body 110. Second, the warp yarns 11 at both sides of each wire assembly 20A are in an arc form and form two elastic adjustment areas 140 along with the weft yarns 12 at both sides of each wire assembly 20A. Preferably, the warp yarns 11 at both sides of each wire assembly 20A are in an asymmetrical arc form.

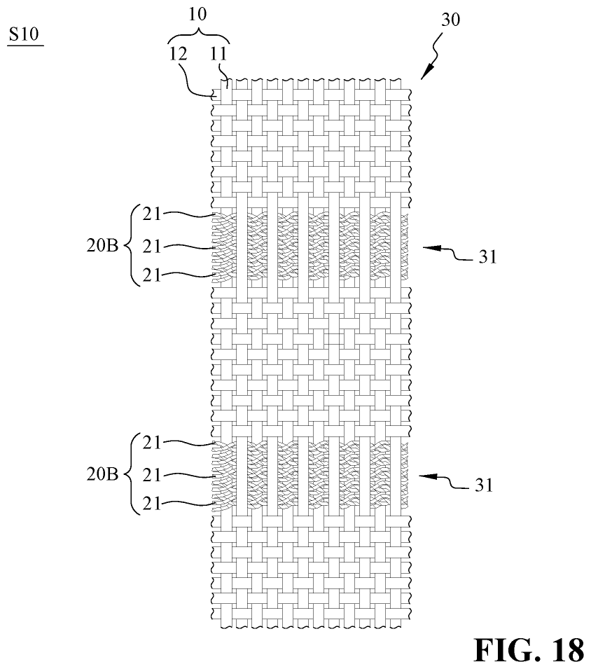

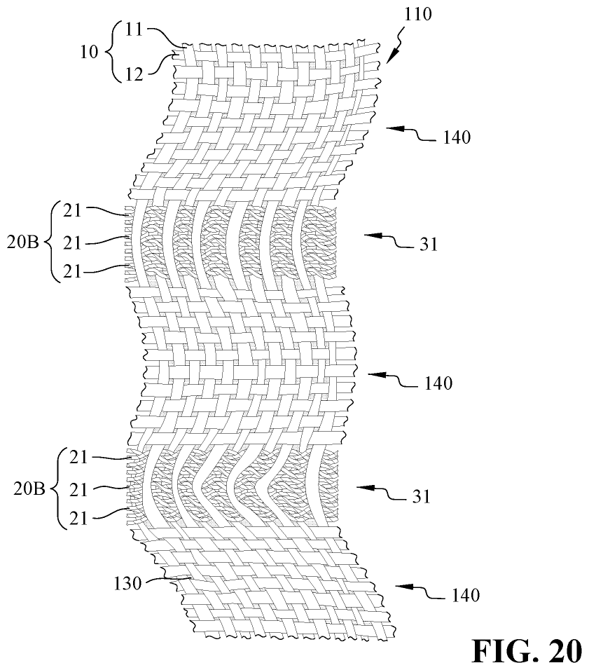

FIG. 18 is a schematic diagram of a step S10 of a manufacturing method of a sixth embodiment of the present invention. As shown in FIG. 18, in terms of method, the sixth embodiment is different from the third embodiment in that, first, in the step S10, the warp yarns 11 extend straightly and are parallel to each other, and the weft yarns 12 and the wire assemblies 20B extend straightly and are perpendicular to the warp yarns 11. Specifically, in the step S10, the warp yarns 11 are arranged at intervals and extend straightly; and the weft yarns 12 and the wire assemblies 20B are arranged at intervals and interwoven with the warp yarns 11, so as to weave a base material 30. Second, in the step S40, the warp yarns 11 at both sides of each wire assembly 20B are in an arc form and form two elastic adjustment areas 140 along with the weft yarns 12 at both sides of each wire assembly 20B (referring to FIG. 20). Preferably, the warp yarns 11 at both sides of each wire assembly 20 are in an asymmetrical arc form (referring to FIG. 20).

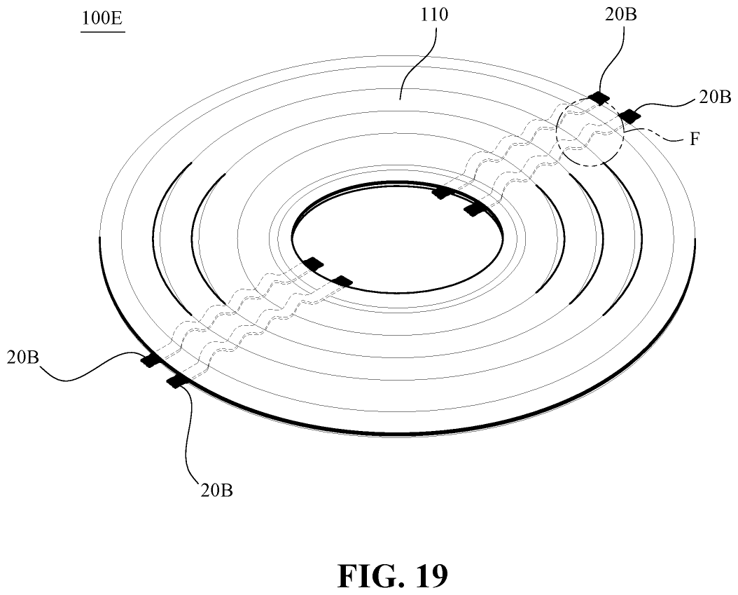

FIG. 19 is a perspective view of a wire damper of loudspeaker 100E of the sixth embodiment of the present invention. FIG. 20 is a schematic diagram of a region F of FIG. 19. As shown in FIGS. 19 and 20, in terms of structure, the sixth embodiment is different from the third embodiment in that, first, the warp yarns 11 extend straightly and are parallel to each other, and the weft yarns 12 and the wire assemblies 20B extend straightly and are perpendicular to the warp yarns 11. Specifically, the warp yarns 11 are arranged at intervals and extend straightly; the weft yarns 12 and the wire assemblies 20B are arranged at intervals and interwoven with the warp yarns 11, so as to weave a main body 110. Second, the warp yarns 11 at both sides of each wire assembly 20B are in an arc form and form two elastic adjustment areas 140 along with the weft yarns 12 at both sides of each wire assembly 20B. Preferably, the warp yarns 11 at both sides of each wire assembly 20B are in an asymmetrical arc form.

In summary, in the present invention, the hardness, elasticity and toughness of the wire disposing areas 31 can be jointly adjusted through the elastic adjustment areas 140, such that the wire disposing areas 31 become softer and have increased elasticity and toughness, the hardness, elasticity, and toughness of the wire disposing areas 31 and the wire assemblies 20, 20A, 20B are comparable to that of the other areas of the wire dampers of loudspeaker 100˜100E. Therefore, the wire dampers of loudspeaker 100˜100E has uniform hardness, elasticity and toughness, thereby having uniform elastic resilience and fatigue resistance, and being not easy to be deformed and brittle, which improves the output sound quality of the loudspeaker.

Those mentioned above are only preferred embodiments for explaining the present invention, but intend to limit the present invention in any forms. Therefore, any modifications or changes related to the present invention made in the same invention spirit should still be included in the scope of the present invention as intended to be claimed.

What is claimed is:

1. A method for manufacturing a wire damper of a loudspeaker with yarns at both sides of a wire assembly being in an arc form, comprising the following steps:
weaving a plurality of yarns into a base material, and disposing a plurality of wire assemblies respectively at a plurality of wire disposing areas of the base material, wherein each wire assembly is composed of a plurality of wires, and each wire is a monofilament thread;
impregnating the base material in a resin solution;
drying the base material to form a solid resin layer on the base material;
forming a wire damper of a loudspeaker on the base material by thermoforming in a manner that the yarns at both sides of each wire assembly are in an arc form to form two elastic adjustment areas; and
separating the wire damper of the loudspeaker from the base material.

2. The method according to claim 1, wherein in the step of disposing the wire assemblies respectively on the wire disposing areas, a plurality of warp yarns of the yarns and the wire assemblies extend straightly and are parallel to each other, and a plurality of weft yarns of the yarns extend straightly and are perpendicular to the warp yarns and the wire assemblies; wherein in the step of forming the wire damper of the loudspeaker by thermoforming, the weft yarns at both sides of each wire assembly are in an arc form and form the elastic adjustment areas along with the warp yarns at both sides of each wire assembly.

3. The method according to claim 1, wherein in the step of disposing the wire assemblies respectively on the wire disposing areas, a plurality of warp yarns of the yarns extend straightly and are parallel to each other, and a plurality of weft yarns of the yarns and the wire assemblies extend straightly and are perpendicular to the warp yarns; wherein in the step of forming the wire damper of the loudspeaker by thermoforming, the warp yarns at both sides of each wire assembly are in an arc form and form the elastic adjustment areas along with the weft yarns at both sides of each wire assembly.

4. The method according to claim 1, wherein in the step of forming the wire damper of the loudspeaker by thermoforming, the yarns at both sides of each wire assembly are in an asymmetrical arc form.

5. The method according to claim 1, wherein in the step of weaving the base material, the wire assemblies are woven, sewn, adhered, or sandwiched into the base material.

6. A wire damper of a loudspeaker with yarns at both sides of a wire assembly being in an arc form, comprising:
a main body, which is woven from a plurality of yarns, and has a plurality of wire disposing areas;
a plurality of wire assemblies, which are disposed respectively on the wire disposing areas, wherein each wire assembly is composed of a plurality of wires, and each wire is a monofilament thread; and
a solid resin layer, which covers surfaces of the yarns and the wires;
wherein the yarns at both sides of each wire assembly are in an arc form to form two elastic adjustment areas.

7. The wire damper of the loudspeaker according to claim 6, wherein the yarns include a plurality of warp yarns and a plurality of weft yarns, the warp yarns and the wire assemblies extend straightly and are parallel to each other, and the weft yarns extend straightly and are perpendicular to the warp yarns and the wire assemblies; wherein the weft yarns at both sides of each wire assembly are in an arc form and form the elastic adjustment areas along with the warp yarns at both sides of each wire assembly.

8. The wire damper of the loudspeaker according to claim 6, wherein the yarns include a plurality of warp yarns and a plurality of weft yarns, the warp yarns extend straightly and are parallel to each other, and the weft yarns and the wire assemblies extend straightly and are perpendicular to the warp yarns; wherein the warp yarns at both sides of each wire assembly are in an arc form and form the elastic adjustment areas along with the weft yarns at both sides of each wire assembly.

9. The wire damper of the loudspeaker according to claim 6, wherein the yarns at both sides of each wire assembly are in an asymmetrical arc form.

10. The wire damper of the loudspeaker according to claim 6, wherein the wire assemblies are woven, sewn, adhered, or sandwiched into the main body.
